(19) United States
(12) Patent Application Publication
(10) Pub. No.: US 2003/0039764 A1
(43) Pub. Date: Feb. 27, 2003

(54) Enhanced surface preparation process for application of ceramic coatings

(76) Inventors: Steven M. Burns, West Hartford, CT (US); Dean N. Marszal, Southington, CT (US)

Correspondence Address: Pratt & Whitney, Legal Department-Patent Section, Mail Stop 132-13, 400 Main Street, East Hartford, CT, 06108, US

(21) Appl. No.: 09/747,713

(22) Filed: Dec. 22, 2000

(51) Int. Cl. B32B 15/04

(52) U.S. Cl. 427/444; 428/633; 416/241 R; 416/241 B; 428/680; 428/612

(57) ABSTRACT

Metallic surfaces are prepared to receive ceramic coatings. An abrasion process of progressively declining intensity removes a portion of the metallic surface. Ceramic coating applied to surfaces so prepared display improved lives at elevated temperatures.

### BACKGROUND

1. Field of the Invention

This invention relates to the preparation of metallic or intermetallic surfaces, particularly bond coat surfaces for the subsequent application of ceramic coatings, particularly ceramic thermal barrier coatings for use at elevated temperatures.

2. Description of Related Art

U.S. Pat. No. 4,321,310 discusses polishing bond coats prior to applying ceramic thermal barrier coatings.

### SUMMARY

Metallic or intermetallic surfaces, particularly bond coat surfaces, are prepared to receive ceramic coatings using a process which includes mechanical abrasion in at least two steps wherein the second step is less aggressive than the first step. Alternately a single step may be employed in which the aggressiveness of the abrasion at the start of the step is greater than the aggressiveness of the abrasion at the end of the step. Abrasion using ceramic particles is a suitable method.

Other steps including diffusion heat treatments, cleaning heat treatments, and mechanical processing such as peening may also be used in conjunction with the progressively decreasing abrasion step.

### BRIEF DESCRIPTION OF THE DRAWINGS

FIGS. 1 through 5 are flow charts which illustrate various embodiments of the invention.

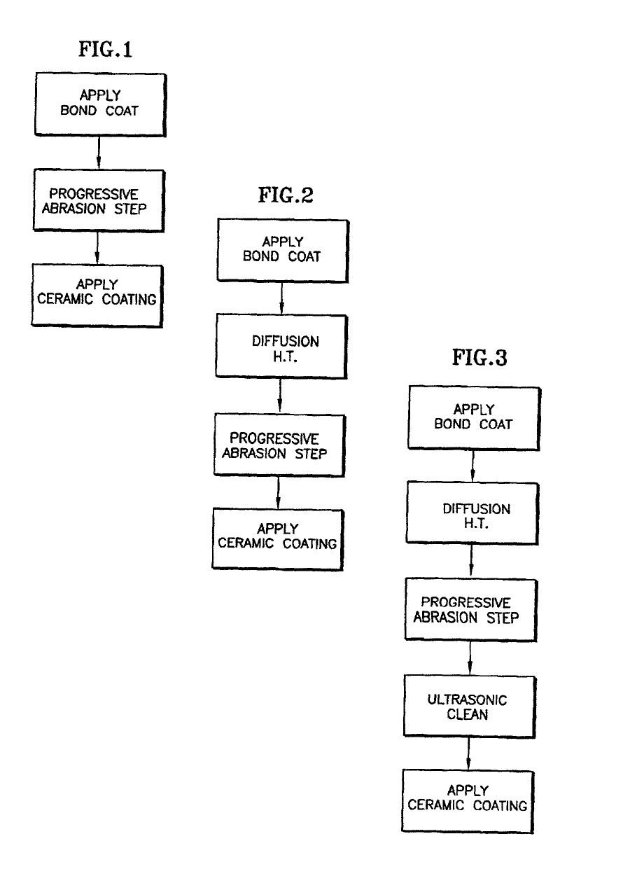

FIG. 6 is a photomicrograph of cross section of a cathodic arc deposited bond coat at 400×.

FIG. 7 is a photomicrograph of cross section of a cathodic arc deposited bond coat at 400× after ceramic pressure peening.

FIG. 8 is a photomicrograph of cross section of a cathodic arc deposited bond coat at 400× after ceramic pressure peening and progressively reduced grit blasting.

### DESCRIPTION OF PREFERRED EMBODIMENTS

The present invention relates to methods for preparing metallic or intermetallic surfaces, particularly bond coat surfaces, to receive a subsequent ceramic coating. The surface preparation process substantially increases the adherence of the ceramic coating to the surface and increases the life of the coating under severe conditions of elevated temperature such as those encountered in gas turbine engines.

Ceramic coating may be applied directly to certain metallic surfaces which form a dense adherent alumina scale, see for example U.S. Pat. No. 5,262,245. Usually however, an intermediate bond coat is applied to the surface prior to the application of the ceramic coating.

The most common type of bond coat known in the art as an MCrAlY bond coat, where M is selected from the group consisting of iron, nickel, cobalt and mixtures of nickel and cobalt. See, for example, U.S. Pat. No. 3,928,026.

MCrAlY type bond coats may be applied using electron beam vapor deposition (EBPVD), cathodic arc deposition, plasma spray deposition including low pressure plasma spraying (LPPS), sputtering, and electrodeposition. While the invention process was specifically developed for use with bond coat supplied by cathodic arc deposition, it is not so limited.

An important aspect of the present invention is the use of an abrasive treatment, having certain specific characteristics, to remove a portion of the surface which is to receive the ceramic coating.

It is often found, particularly with respect to some types of bond coat deposition processes such as cathodic arc, that the surface of the as-applied bond coat has defects, such as pores, fissures, etc. and is rough and irregular.

According to the present invention, a portion of the surface which is to receive the ceramic coating is removed by abrasion to a depth which removes any imperfect outer portion of the surface layer which may be present. Generally speaking, a total of up to about 1.0 mil (0.0010 in.) may be removed. Most commonly, for cathodic arc deposited coatings, between about 0.0005 and 0.0010 in. (0.5-1.0 mil) will be removed.

We have found that using a relatively aggressive initial abrasive treatment followed by at least one subsequent, less aggressive, abrasive treatment results in a substantially increased life for a subsequently applied ceramic coating. We define the degree of aggressiveness of an abrasive surface treatment in terms of the rate of surface removal, the unit thickness removed per unit time. More aggressive abrasive treatments remove more material in a given period of time.

Thus, for example, we have used grit blasting in which alumina particles are propelled by a fluid (such as compressed air) against the surface to be abraded. The aggressiveness of the abrasive process can be controlled by controlling velocity and/or pressure of the fluid which contains and propels the abrasive media and/or the nozzle to substrate distance. In general, higher fluid pressures/velocities produce a more aggressive abrasive treatment than do lower fluid pressures/velocities as do reduced nozzle-substrate distances, assuming that other process details remain constant.

While it is, as noted above, necessary to use at least two abrasive treatments of decreasing intensity, it is preferred to use at least three abrasive treatments of decreasing intensity.

It will also be appreciated that the same result can be achieved using a single abrasive treatment step in which the degree of aggressiveness of the abrasive process is varied and decreases from the start of the step to the finish of the step. The nature of the decrease may be stepwise or continuous, or combinations thereof. Thus, for example, instead of using two or three separate grit blasting steps using progressively lower air pressure, it is possible to use a single grit blasting operation in which the air pressure decreases from the start of the step to the end of the step. It is also possible to combine constant abrasive aggressiveness with one or more steps of degreasing abrasive aggressiveness.

Oxide ceramic abrasives are preferred because any residual embedded particles will be relatively stable and innocuous. We prefer to use alumina as an abrasive material but other abrasives, including zirconia and silica, may be used especially for the earlier abrasive treatment steps. Use of alumina for the final, least aggressive, abrasion step is highly preferred.

It has been found that using a decreasing intensity abrasive process or processes produces a relatively smoother surface finish than would otherwise be obtained if an abrasive step of constant intensity were utilized.

The skilled artisan will appreciate that several factors affect the intensity or rate of abrasion of a given surface. These include abrasive particle size, abrasive particle composition, abrasive particle velocity, the angle at which the particles strike the surface, and the number of particles interacting with a unit surface area in a unit time and the nozzle to substrate distance.

It is well within the skill of the art to select and vary these factors to arrive at a suitable combination to accomplish the present invention.

A variety of abrasion processes are known in the art, including:

1. Grit blasting wherein abrasive particles are propelled at a surface

a. by a flowing gas stream

b. by a flowing liquid stream

c. by centrifugal force imparted by a rotating disc or wheel.

2. Vibratory finishing wherein the parts to be abraded are placed in a container along with abrasive media (often with a liquid added) and the container is vibrated to cause the abrasive media to abrade the parts.

3. Barrel finishing, similar to vibratory finishing except that the container is closed and rotated about a generally horizontal axis to cause motion (tumbling) and abrasion.

4. Centrifugal disc finishing in which a rotating disc spins abrasive media and parts in a stationary chamber.

5. Centrifugal barrel finishing which uses closed chambers, containing parts and abrasive media, which are mounted on a rotating turret. The closed chambers counter rotate.

6. Spindle finishing in which parts are mounted on movable spindles which are then immersed in a moving bed of abrasive media.

7. Drag finishing in which parts are mounted on rotating fixtures which are immersed in and dragged through a bed of abrasive media.

All of these techniques can potentially be used in connection with the present invention, although some may remove material at such a high rate as to be impractical.

In practical applications, contamination of hollow parts, such as cooled turbine airfoils, with abraded debris/sludge can be a problem. This suggests that liquid media processes may be generally less suitable.

FIG. 2 shows further development of the present invention in which a diffusion heat treat step is performed between the bond coating application step and the progressive abrasion step. It is known in the prior art to perform diffusion heat treat steps in connection with bond coats in order to improve their adherence to the substrate by promoting interdiffusion between the bond coat and the substrate. Such a diffusion heat treatment step appears to be highly desired in the case of cathodic arc-applied bond coats which, because they are deposited at relatively low temperatures and have relatively low adherence in the as-applied state. A diffusion heat treatment is not required if the ceramic coating is to be applied directly to a substrate without a bond coat.

A typical diffusion heat treatment step is performed at a temperature of 1975° F. for a period of about four hours. Temperatures between about 1800° F. and about 2100° F. may be employed for times ranging from about one-half hour up to about 20 hours.

FIG. 3 shows another step which is added to the step shown in FIG. 2 which comprises an ultrasonic cleaning step performed after the progressive abrasion step. It has been found that the abrasive operation produces fine particles of the abrasive material and the abraded material which are difficult to remove from the surface using cleaning methods such as air blasting. Ultrasonic cleaning using an aqueous solution has been used. Pure water has been used but it is possible to employ wetting agents, which may enhance the cleaning effectiveness, but care must be taken to ensure that any ultrasonic cleaning solution residue does not interfere with adherence of the ceramic layer to be deposited.

FIG. 4 shows another step added to the steps in FIG. 3 which consists of a peening operation which is performed either immediately after the diffusion heat treatment and before the progressive abrasion step, or alternately after the first abrasion step. Peening is used to densify bond coats by closing internal voids and other defects. We prefer to use ceramic pressure peening. Ceramic pressure peening is similar in some ways to grit blasting. A pressure fed type grit blasting machine propels ceramic particles at the surface to be peened. Smooth rounded ceramic particles are used and minimal surface removal occurs. We have used a commercially available material known as Zirshot, a product of SEPR of Paris, France, a unit of the St. Gobain Corporation, the media is available from SEPR of Mountainside, N.J. We use round particles having an average diameter of 0.046 in. Zirshot is an alloy of zirconia and silica.

We prefer to peen to an intensity as measured by the Almen test strip method, of from about 13-17 N, more specifically 14-16 N. Ceramic pressure peening is preferred because it has been found not to damage delicate parts to the extent that some other peening methods do, however generally speaking any peening method may be used which provides the required Almen intensity without damaging the part or contaminating the part surface.

FIG. 5 shows another step added to the step shown in FIG. 4, a heat treatment performed after any peening operation but prior to ultrasonic cleaning. This heat treatment is used to remove any organic residue or contamination such as that left by fingerprints or oil vapors in the ambient atmosphere. A heat treatment at about 1300° F. for about one-half hour, but temperatures between about 1000° F. and 1500° F. for times between about one-half hour and 4 hours are appropriate.

We prefer that all part handling after the organic heat treatment step is performed by operators wearing fabric or plastic gloves to eliminate the possibility of subsequent organic contamination.

After the surface is prepared, the ceramic coating can be applied by EBPVD, sputtering, or thermal spray techniques.

### EXAMPLE 1

Twelve gas turbine blades having a nominal composition of (by wt.) 5% Cr, 10% Co, 2% Mo, 6% W, 3.1% Re, 5.6% Al, 9% Ta, 0.1% Hf, bal essentially Ni, were coated with an MCrAlY having a nominal composition of (by wt.) 22% Co, 17% Cr, 12.5% Al, 0.25% Hf, 0.4% Si, 0.6% Y, bal essentially Ni, using a cathodic arc coating process. The nominal coating thickness was 4 mil.

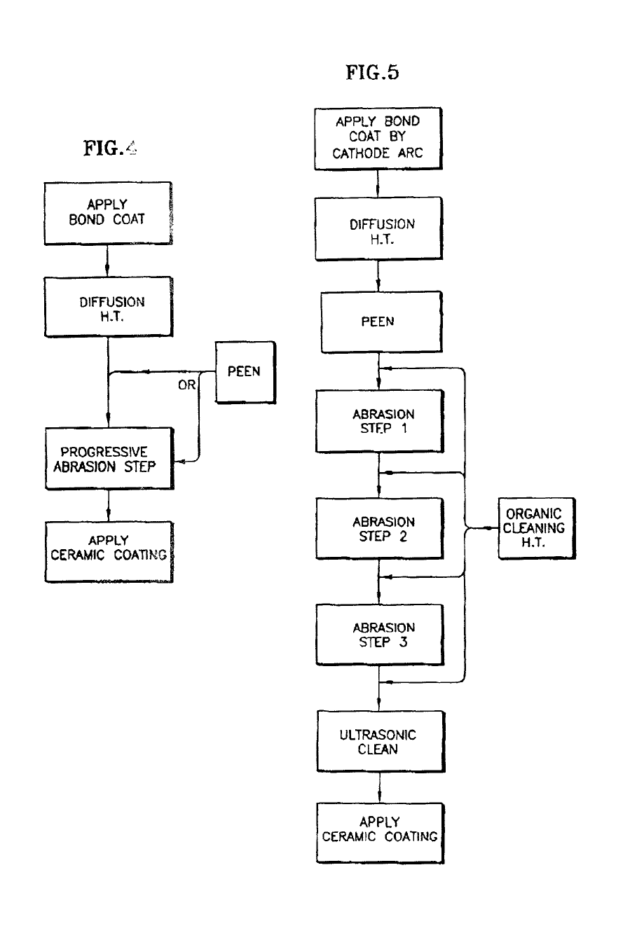

FIG. 6 shows a cross sectional photo micrograph (at 400×) of the as applied coating. The rough surface is readily visible, and had a measured roughness of about 195 microinches R.A.

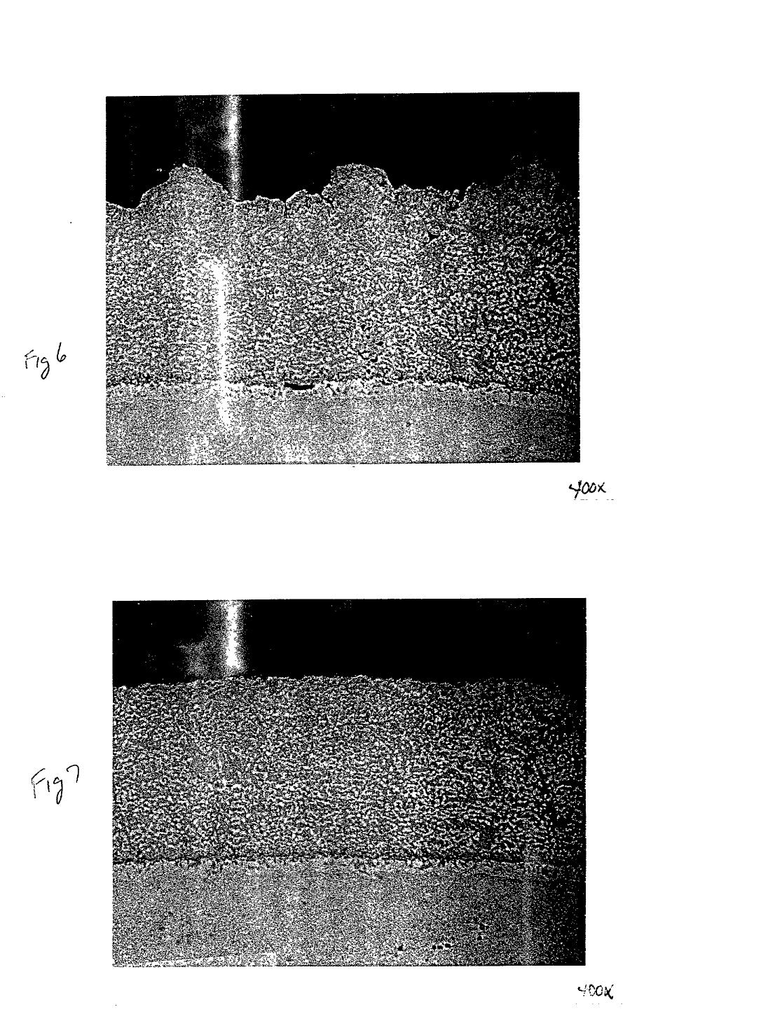

The as coated blades were treated by ceramic pressure peening, using ceramic beads Zirshot, 0.046 in dia., applied using a pressure feed peening apparatus operated at a constant air pressure of 30 psi for 5 minutes. FIG. 7 is a photomicrograph showing the surface after ceramic pressure peening. A significant improvement in surface condition is visible, the measured surface roughness after peening was about 135 microinches R.A.

The pressure peened parts then had a columnar ceramic coating applied by EBPVD. The ceramic coating composition was zirconia stabilized with 7 wt % ytttria. The ceramic coating thickness was about 5 mil.

The ceramic coated parts were tested in a cyclic thermal (at 2100° F.) test simulating engine operation.

The average time to coating failure (defined as about 50% spallation of the ceramic coating) was determined.

### EXAMPLE 2

Six turbine blades of the same composition as those described in Example 1. The six blades were coated with the same MCrAlY composition to the same thickness using the same cathodic apparatus.

Ceramic pressure peening was performed according to the present invention using the same pressure peening apparatus and peening media as that used in Example 1.

The six parts were then grit blasted as follows: two minutes at 75 psi, 2 minutes at 55 psi and 1 minute at 35 psi using 240 mesh aluminum oxide grit. After this progressively reduced aggressiveness processing, the measured surface roughness was 69 microinches R.A.

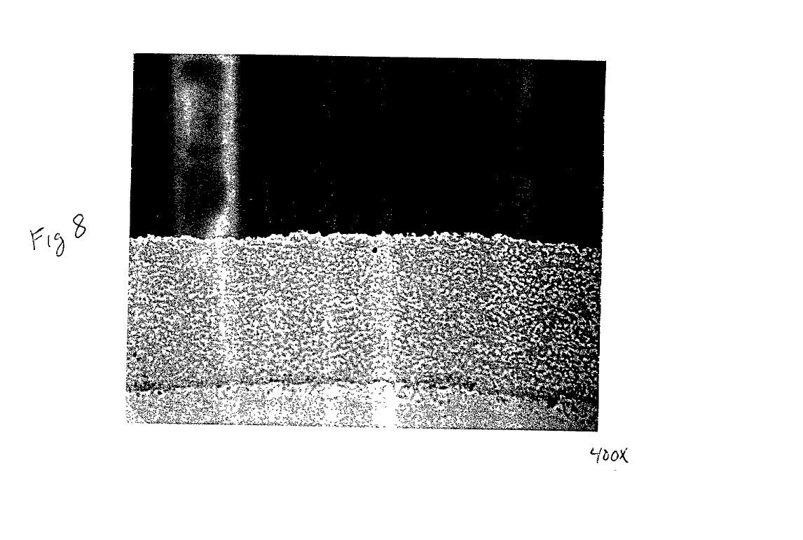

After grit blasting at progressively reduced intensity, the parts were coated with the same EBPVD applied ceramic coating as used in Example 1 to the same thickness. FIG. 8 shows a cross section with the ceramic coating applied.

The six parts were tested using the same 2100° F. cyclic test as used in Example 1.

The sample processed according to the present invention displayed an 87% improvement in cyclic life.

1. A method for preparing a substrate to receive a ceramic coating including the steps of:
removing material from the surface at a progressively decreasing rate.

2. A method as in claim 1 in which the material is removed by abrasion and which includes at least two abrasion steps and wherein the first step removes material at a rate which is at least twice the rate of the last abrasion step.

3. A method as in claim 1 in which an abrasion process of decreasing intensity is employed.

4. A method as in claim 2 which includes at least three abrasion steps of progressively reducing intensity.

5. A method as in claim 1 wherein the abrasion is caused by oxide ceramic abrasive particles.

6. A method as in claim 1 wherein the abrasion is caused by grit blasting.

7. A method as in claim 1 wherein the surface has a bond coat.

8. A method as in claim 1 wherein the surface has a bond coat which is an MCrAlY coating.

9. A method as in claim 6 wherein the bond coat is an MCrAlY bond coat which has been applied by a method selected from the group consisting of EBPVD, cathodic arc deposition, plasma spray deposition, electroplating, and sputtering.

10. A method as in claim 1 in which a diffusion heat treatment is performed prior to the progressively decreasing rate material removal process step.

11. A method as in claim 1 in which an ultrasonic cleaning step is performed subsequent to the progressively decreasing rate material removal process step.

12. A method as in claim 10 in which a surface peening operation is performed subsequent to the diffusion heat treatment step.

13. A method for applying a ceramic thermal barrier coating to a metallic substrate including the steps of:
a) applying an MCrAlY bond coat to the substrate using a cathodic arc deposition process
b) diffusion heat treating the coated substrate
c) peening the diffusion heat treated coated substrate
d) abrasively removing material from the bond coat at a progressively reducing rate
e) ultrasonically cleaning the abrasively treated bond coat
f) applying a ceramic coating.

14. A method as in claim 13 wherein the abrasive removal process is performed using oxide ceramic abrasive materials.

15. A method as in claim 13 wherein the abrasive removal process occurs at an initial rate which is at least twice as great as the rate of removal at the end of the abrasive removal process.

16. A process as in claim 13 wherein the peening is performed to an intensity of from 13-17 N on the Almen scale.

17. A process as in claim 13 wherein the diffusion heat treatment is performed at a temperature of from about 1800° to about 2100° F. for a time of from about 0.5 to about 10 hours.

18. The product produced by the method of claim 1.

19. The product produced by the method of claim 10.

20. The product produced by the method of claim 13.

21. The product produced by the method of claim 17.
